(19) United States
(12) Patent Application Publication
(10) Pub. No.: US 2020/0192623 A1
(43) Pub. Date: Jun. 18, 2020

(54) OBJECT CONCEALMENT SYSTEM AND METHOD

(71) Applicant: Hagop Oughourlian, Montreal (CA)

(72) Inventor: Hagop Oughourlian, Montreal (CA)

(21) Appl. No.: 16/659,634

(22) Filed: Oct. 22, 2019

Related U.S. Application Data
(60) Provisional application No. 62/780,065, filed on Dec. 14, 2018.

(51) Int. Cl. G06F 3/14; H04N 5/247; F41H 3/00

(52) U.S. Cl. CPC G06F 3/1446; F41H 3/00; H04N 5/247

(57) ABSTRACT

A digital concealment system includes a series of cameras and a series of displays which are in digital communication with each other. The series of displays are arrayed on one side of an object to be concealed, and the cameras are arrayed on an opposite side of the object. Each display is a flexible organic light emitting diode screen that can be flexibly conformed and attached to a planar or curved surface. Each camera is in digital communication one display, such that an image captured by that camera is displayed by the conjoined display in real-time. Each associated pair of display and camera face opposite directions. In this way, because they are oriented oppositely and coaxially, the display displays an image nearly identical to what a viewer would see if the concealed object was not present. Effectively, this illusion has the effect of making the object seem invisible.

### CROSS-REFERENCE TO RELATED APPLICATION(S)

The present application is related to and claims priority to U.S. Provisional Patent Application No. 62/780,065 filed Dec. 14, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of image capturing of existing art and more specifically relates to digital camouflaging systems.

### Related Art

People value their privacy. For numerous reasons, people may have to mask their identity, location, and/or personal objects. Government and military may need to hide objects. A suitable solution is desired.

U.S. Pat. No. 9,175,930 to Narek Pezeshkian et al. relates to adaptive electronic camouflage. The described adaptive electronic camouflage includes an adaptive electronic camouflage platform comprising electronic paper panels conformed to the exterior surface of the vehicle; one or more cameras for sampling images of the local environment surrounding the platform; and a processor for analyzing the sampled images, generating synthesized camouflage patterns corresponding to the sampled images and controlling the display of the synthesized camouflage patterns on the electronic paper panels.

### SUMMARY OF THE INVENTION

In view of the foregoing disadvantages inherent in the known digital camouflaging system art, the present disclosure provides a novel object concealment system and method. The general purpose of the present disclosure, which will be described subsequently in greater detail, is to provide an object concealment system and method.

A digital concealment system is disclosed herein. The digital concealment system includes a series of cameras and a series of displays which are in digital communication with each other. The series of displays are arrayed on one side of the object, and the cameras are arrayed on an opposite side of the object. Each display is a flexible OLED (organic light emitting diode) screen that can be flexibly conformed and attached to a planar or curved surface. Each camera is in digital communication one display, such that an image captured by that camera is displayed by the conjoined display in real-time. Each display is associated with and digitally conjoined to a single camera. Each camera of the series of cameras is oriented in a recording-direction, and each display of the series of displays is oriented in a viewing-direction, with the recording-direction and the viewing-direction being more or less co-axial. Further, the camera faces the opposite direction of the conjoined display. In this way, because they are oriented oppositely and coaxially, the display displays an image nearly identical to what a viewer would see if the concealed object was not present. Effectively, this illusion has the effect of making the object seem invisible.

According to another embodiment, a method of concealing an object is also disclosed herein. The method of concealing an object includes providing the above-described digital concealment system, capturing a series of images via each of the cameras of the series of cameras, displaying the series of images via each of the displays of the series of displays, and repeating the process of capturing and displaying new images per a time interval.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an object concealment system and method, constructed and operative according to the teachings of the present disclosure.

FIG. 1 is a perspective view of the object concealment system during an ‘in-use’ condition, according to an embodiment of the disclosure.

FIG. 2 is a perspective view of the object concealment system of FIG. 1, according to an embodiment of the present disclosure.

FIG. 3 is a perspective view of the object concealment system of FIG. 1, according to an embodiment of the present disclosure.

FIG. 4 is a perspective view of the object concealment system of FIG. 1, according to an embodiment of the present disclosure.

FIG. 5 is a flow diagram illustrating a method of use for actively concealing an object, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a digital camouflaging system and more particularly to an object concealment system and method as used to improve the active concealment of an object such as a vehicle.

Generally, the concealment system enables users to render items indistinguishable from surroundings via OLED screens and cameras. The system allows users to install the OLED screens on the front side of an object to prepare the masking. It utilizes a series of cameras capable of capturing landscape images when installed behind the object, working in conjunction with the OLED screens to render the item invisible when a picture is taken. The present invention enables users to maintain a sense of privacy without compromising their items, location, etc.

The digital concealment system is an electronic system designed to camouflage objects to the naked eye. The system makes objects appear invisible or translucent. The system is comprised of a series of cameras and flexible, moldable OLED screens. The screens are attached to the front side of an object. One or more screens can be applied. The cameras are attached to the rear side of an object. The screens display landscape while the cameras capture the surrounding environment. Both works in conjunction to make the object being hidden appear invisible while still taking a photograph of the environment. The OLEDs may be applied to any metal, wooden, or soft object such as cars, planes, desks, chairs, and clothing. Exact specifications of the system may vary upon further development.

In one embodiment, the system may apply to an OLED application and display system whereby an OLED screen is applied to a surface of an object. The OLED screen may be coupled to a transceiver. The transceiver may be in electronic communication with an electronic device. The electronic device may communicate remotely and wirelessly with the transceiver. The transceiver may be able to connect with the OLED screen to display static images or video on the OLED screen.

For the purposes of this specification, “recording-direction” is defined as the direction towards which the recording lens of a camera is centrally pointed. “Viewing-direction” is defined as the direction from which a display can be most centrally viewed from.

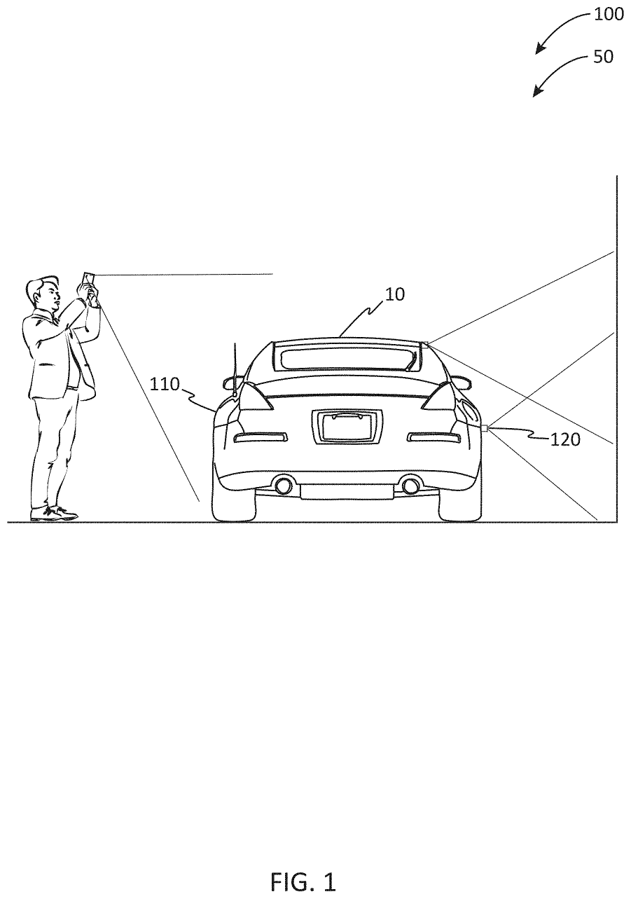

Referring now more specifically to the drawings by numerals of reference, there is shown in FIGS. 1-4, various views of a concealment system 100.

FIG. 1 shows a concealment system during an ‘in-use’ condition 50, according to an embodiment of the present disclosure. Here, the concealment system may be beneficial for use by a user 40 to actively conceal an object. As illustrated, the concealment system 100 m may include displays 110 and cameras 120 disposed on object 10. As illustrated, object 10 is a vehicle. However, system 100 may be applied to other objects besides a vehicle.

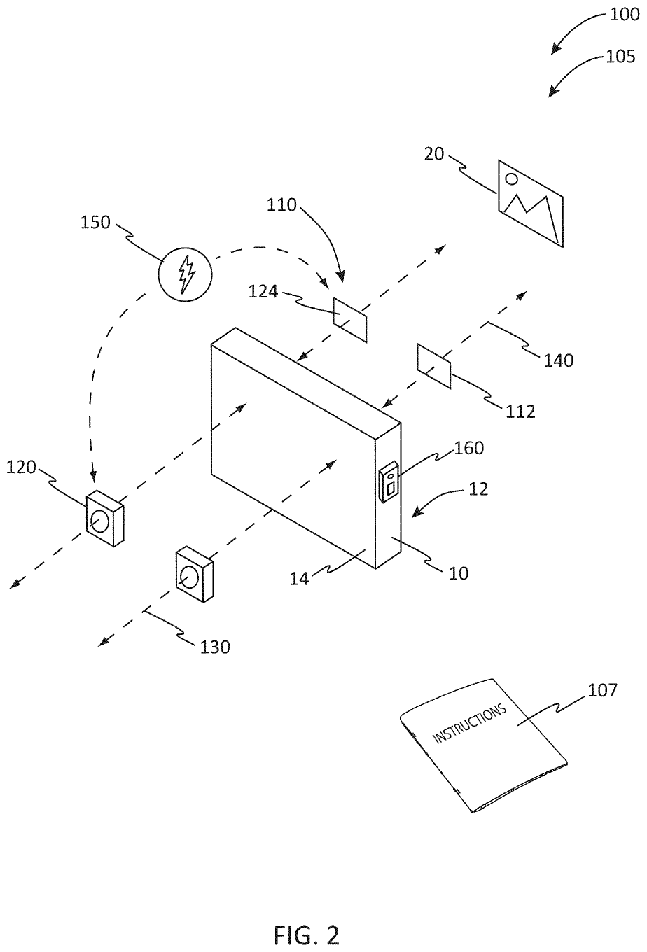

FIG. 2 shows the concealment system of FIG. 1, according to an embodiment of the present disclosure. As above, the concealment system 100 may include displays 110 and cameras 120 disposed on object 10. System 100 may be useful for effectively concealing or camouflaging object 10. Object 10 may be a vehicle. System 100 may include series of displays 110 and series of cameras 120. Series of displays 110 may be placed on first-side 12 of object 10. Each of the displays 110 may be a flexible OLED-based screen 112. Series of cameras 120 may be placed on second-side 14 of object 10. Each camera of series of cameras 120 may be in digital communication with one display of series of displays 110, such that an image 20 captured by each camera 120 is displayed by a conjoined display 110 in real-time. In this way, each display of series of displays 110 may be associated with a single camera of series of cameras 120, and accordingly, each camera of series of cameras 120 may be in digital communication with its associated display 110. Importantly, each camera 120 and conjoined display 110 are oriented in opposite directions from each other. Each camera of series of cameras 120 is oriented in a recording-direction 130, and each display of series of displays 110 is oriented in a viewing-direction 140. Recording-direction 130 of each camera 120 is substantially coaxial within five degrees of viewing-direction 140 of an associated display 110 of camera 120. In this way, each display 110 shows a view very similar to what a viewer would see if object 10 was not present. The image 20 generated by camera 120 and displayed by conjoined display 110 allows a viewer's line of sight to effectively (if not literally) pass through object 10. When multiples of displays 110 and cameras 120 are arrayed over object 10, this illusory effect is permeated over the entirety of object 10. Effectively, object 10 becomes invisible to a viewer when system 100 is implemented and active. Preferably, each flexible OLED-based screen 112 is rectangular in shape when flexible OLED-based screen 112 is laid flat on a plane. Each camera 110 may be in either wired or wireless communication with each conjoined display 120.

In some embodiments, system 100 may further comprise controller 160. Controller 160 may conjoin each camera 120 with associated display 110 in electrical communication, such that each image 20 captured by each camera 120 is communicated digitally to controller 160 before being communicated to the associated camera 120. Each display of series of displays 110 may further comprise adhesive layer 124 able to fasten the display to object 10. Likewise, each camera of the series of cameras 120 may further comprise adhesive layer 124 able to fasten the display to object 10. System 100 may further comprise power source 150 able to power each camera of series of cameras 120 and each display of series of displays 110. In some embodiments, power source 150 may include at least one battery. In other embodiments, power source 150 may include at least one photovoltaic cell. Power source 150 may be a single unit central to all of series of displays 110 and series of cameras 120 or may be multiple individual power sources associated with individuals of series of displays 110 and series of cameras 120.

According to one embodiment, the concealment system 100 may be arranged as a kit 105. In particular, the concealment system 100 may further include a set of instructions 107. The instructions 107 may detail functional relationships in relation to the structure of the concealment system 100 such that the concealment system 100 can be used, maintained, or the like, in a preferred manner.

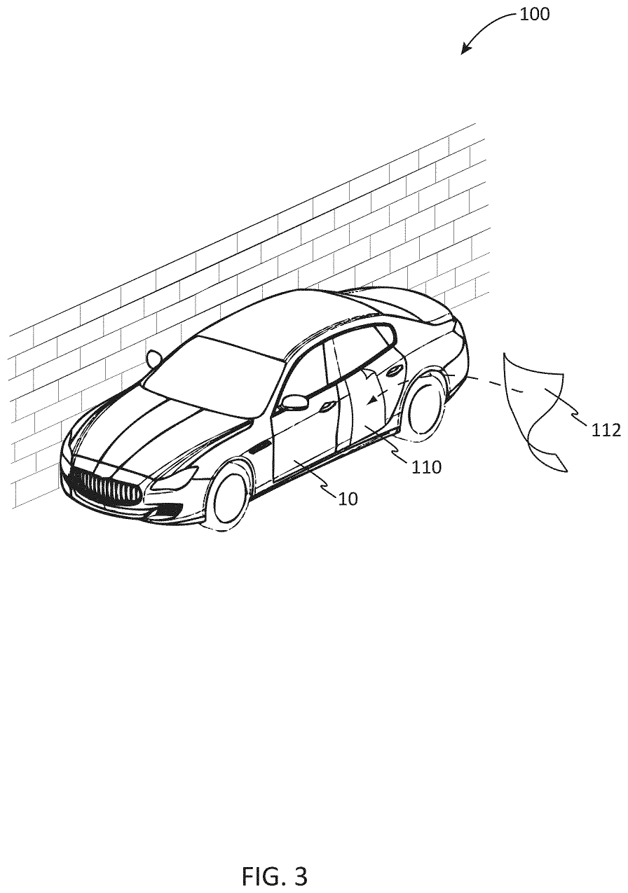

FIG. 3 is a perspective view of the system 100 of FIG. 1, according to an embodiment of the present disclosure. As illustrated, each display of series of displays 110 may be a flexible OLED-based screen 112. The OLEDS may be disposed on a substrate composed of plastic, metal, glass, or other materials. Preferably, the substrate is a polymer or composite having high enough flexibility and resiliency to be applied to curved body panels on a vehicle or other curved object 10.

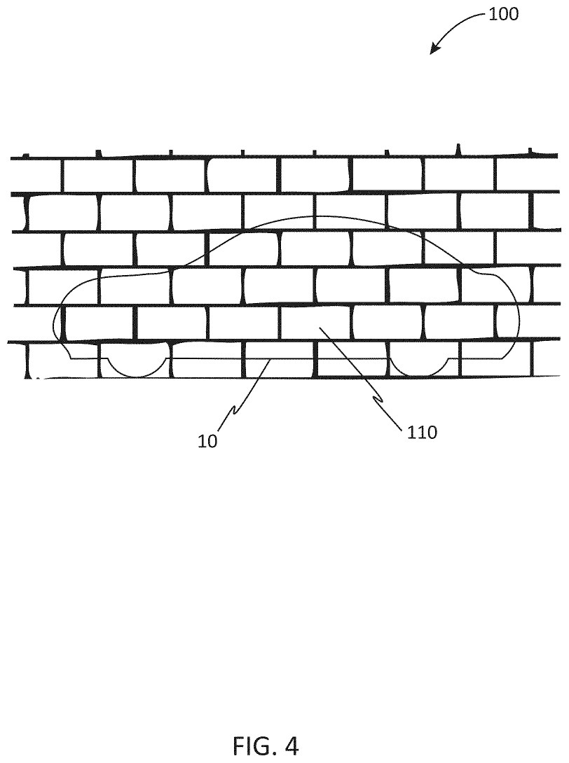

FIG. 4 is a perspective view of the system 100 of FIG. 1, according to an embodiment of the present disclosure. As illustrated, multiple displays of series of displays 110 may be arrayed adjacently and sequentially over object 10 in order to apply the concealing or camouflaging effect to the entirety of object 10. Preferably, each display of series of displays 110 is substantially rectangular so that multiple displays of series of displays 110 can be arrayed as shown.

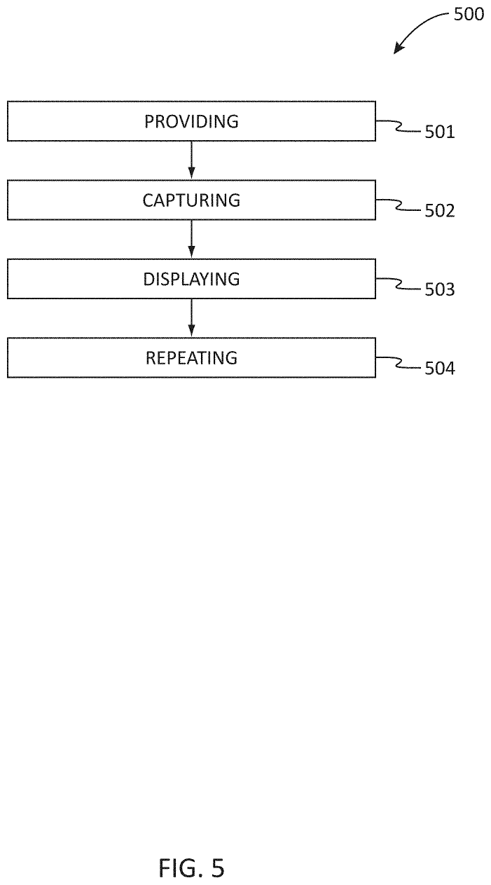

FIG. 5 is a flow diagram illustrating a method for actively concealing an object, according to an embodiment of the present disclosure. In particular, the method for actively concealing an object 500 may include one or more components or features of the concealment system 100 as described above. As illustrated, the method for actively concealing an object 500 may include the steps of: step one 501, providing a system for camouflaging an object, the system comprising: a series of displays placed on a first-side of the object, each of the displays being a flexible OLED-based screen, and a series of cameras placed on a second-side of the object, each camera of the series of cameras being in digital communication with one display of the series of displays, such that an image captured by each camera is displayed by a conjoined display in real-time, wherein each display of the series of displays is associated with a single camera of the series of cameras, each camera of the series of cameras being in digital communication with its associated display, wherein each camera of the series of cameras is oriented in a recording-direction, and each display of the series of displays is oriented in a viewing-direction, and wherein the recording-direction of each camera is substantially coaxial within five degrees of the viewing-direction of the camera's associated display; step two 502, capturing a series of images via each of the cameras of the series of cameras; step three 503, displaying the series of images via each of the displays of the series of displays; and step four 504, repeating the process of capturing and displaying new images per a time interval.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for actively concealing an object, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An OLED application and display system comprising:
an object having at least one surface;
at least one OLED screen;
a transceiver electronically coupled to the OLED screen and able to display at least one image on the OLED screen, whereby the image can be static or video;
at least one electronic device in wireless communication with the transceiver;
wherein the at least one OLED screen is applied to the surface.

2. A system for camouflaging an object, the system comprising:
a series of displays placed on a first-side of the object, each of the displays being a flexible OLED-based screen; and
a series of cameras placed on a second-side of the object, each camera of the series of cameras being in digital communication with one display of the series of displays, such that an image captured by each camera is displayed by a conjoined display in real-time;
wherein each display of the series of displays is associated with a single camera of the series of cameras, each camera of the series of cameras being in digital communication with its associated display;
wherein each camera of the series of cameras is oriented in a recording-direction, and each display of the series of displays is oriented in a viewing-direction; and
wherein the recording-direction of each camera is substantially coaxial within five degrees of the viewing-direction of the camera's associated display.

3. The system of claim 1, wherein the object is a vehicle.

4. The system of claim 1, wherein each flexible OLED-based screen is rectangular in shape when the flexible OLED-based screen is laid flat on a plane.

5. The system of claim 1, wherein each camera is in wireless communication with the conjoined display.

6. The system of claim 1, wherein each camera is in wired communication with the conjoined display.

7. The system of claim 1, further comprising a controller conjoining each camera with the associated display in electrical communication, such that each image captured by each camera is communicated digitally to the controller before being communicated to the associated camera.

8. The system of claim 1, wherein each display of the series of displays further comprises an adhesive layer able to fasten the display to the object.

9. The system of claim 1, wherein each camera of the series of camera further comprises an adhesive layer able to fasten the display to the object.

10. The system of claim 1, further comprising a power source able to power each camera of the series of cameras and each display of the series of displays.

11. The system of claim 9, wherein the power source comprises at least one battery.

12. The system of claim 9, wherein the power source comprises at least one photovoltaic cell.

13. A digital concealment system for camouflaging a vehicle, the digital concealment system comprising:
a series of displays placed on a first-side of the object, each of the displays being a flexible OLED-based screen; and
a series of cameras placed on a second-side of the object, each camera of the series of cameras being in digital communication with one display of the series of displays, such that an image captured by each camera is displayed by a conjoined display in real-time;
wherein each display of the series of displays is associated with a single camera of the series of cameras, each camera of the series of cameras being in digital communication with its associated display;
wherein each camera of the series of cameras is oriented in a recording-direction, and each display of the series of displays is oriented in a viewing-direction;
wherein the recording-direction of each camera is substantially coaxial within five degrees of the viewing-direction of the camera's associated display;
wherein the object is a vehicle;
wherein each flexible OLED-based screen is rectangular in shape when the flexible OLED-based screen is laid flat on a plane;
wherein each camera is in wireless communication with the conjoined display;
further comprising a controller conjoining each camera with the associated display in electrical communication, such that each image captured by each camera is communicated digitally to the controller before being communicated to the associated camera;
wherein each display of the series of displays further comprises an adhesive layer able to fasten the display to the object;
wherein each camera of the series of camera further comprises an adhesive layer able to fasten the display to the object; and
further comprising a power source able to power each camera of the series of cameras and each display of the series of displays.

14. The system of claim 13, further comprising set of instructions; and
wherein the system is arranged as a kit.

15. A method of concealing an object, the method comprising the steps of:
providing a system for camouflaging an object, the system comprising: a series of displays placed on a first-side of the object, each of the displays being a flexible OLED-based screen, and a series of cameras placed on a second-side of the object, each camera of the series of cameras being in digital communication with one display of the series of displays, such that an image captured by each camera is displayed by a conjoined display in real-time, wherein each display of the series of displays is associated with a single camera of the series of cameras, each camera of the series of cameras being in digital communication with its associated display, wherein each camera of the series of cameras is oriented in a recording-direction, and each display of the series of displays is oriented in a viewing-direction, and wherein the recording-direction of each camera is substantially coaxial within five degrees of the viewing-direction of the camera's associated display;
capturing a series of images via each of the cameras of the series of cameras;
displaying the series of images via each of the displays of the series of displays; and
repeating the process of capturing and displaying new images per a time interval.
